(19) United States
(12) Patent Application Publication
(10) Pub. No.: US 2025/0314114 A1
(43) Pub. Date: Oct. 9, 2025

(54) WINDOW STRUCTURE, DOOR WINDOW ASSEMBLY AND AUTOMOBILE

(71) Applicant: FUYAO GLASS INDUSTRY GROUP CO., LTD., Fuqing City Fuzhou (CN)

(72) Inventors: Liqiang WANG, Fuqing (CN); Hua CHEN, Fuqing (CN); Huaiyuan WANG, Fuqing (CN); Ke ZHANG, Fuqing (CN); Maorong ZHAN, Fuqing (CN); Yuzhou LI, Fuqing (CN)

(21) Appl. No.: 18/865,883

(22) PCT Filed: Jun. 19, 2023
(86) PCT No.: PCT/CN2023/100955

§ 371 Date: Nov. 14, 2024

(30) Foreign Application Priority Data
Jun. 20, 2022 (CN) 202210697274.5

(51) Int. Cl. E05F 15/635; B60J 1/16; E05F 15/655

(52) U.S. Cl. CPC E05F 15/635; B60J 1/16; E05F 15/655

(57) ABSTRACT

In one aspect, a window structure includes a first transmission member driven by a first output portion to drive a first door window to move, and a second transmission member driven by a second output portion to drive a second door window to move. The first transmission member and the second transmission member are arranged along the extending direction M of the opening and closing side. The power input portion of the drive member is arranged at intervals with the first transmission member and the second transmission member along the height direction M of the window aperture. The first output portion and the second output portion are arranged along the extending direction M of the opening and closing side.

### CROSS-REFERENCE TO RELATED APPLICATIONS

The application claims priority to Chinese patent application No. 2022106972745, entitled “WINDOW STRUCTURE, DOOR WINDOW ASSEMBLY AND AUTOMOBILE”, filed on Jun. 20, 2022, the disclosure of which is hereby incorporated by reference in its entirety.

### TECHNICAL FIELD

The present disclosure relates to the technical field of automobiles, in particular to a window structure, a door window assembly and an automobile.

### BACKGROUND

The comfort and convenience requirements of windows for modern automobiles are becoming higher and higher, and electric windows have increasingly become a common configuration of automobiles. The so-called electric window drives a door window to move through corresponding driving device, so as to open or close the door window. The electric window can allow a driver or passenger to open or close the door window automatically using a switch when sitting on a seat, which is easy to operate and beneficial to driving safety. It has become the first choice for the window design of each original equipment manufacturers (OEMs).

However, the arrangement of the driving device in conventional electric windows is not compact and occupies a large space in the height direction of a window opening, which affects the assembly of other components.

### SUMMARY

According to various embodiments of the present disclosure, a window structure, a door window assembly, and an automobile are provided.

The technical solutions are described in the following.

In one aspect, the present disclosure relates to a window structure including a carrier, a window assembly and a driving assembly. The carrier has a window opening formed thereon, and a side of the window opening is an opening and closing side. The window assembly includes first door window and a second door window that are arranged along an extending direction of the opening and closing side. The first door window and the second door window are configured to cooperate with each other to open or close the window opening. The driving assembly includes a driving member, a first transmission member and a second transmission member. The first transmission member and the second transmission member are arranged along the extending direction of the opening and closing side, and both the first transmission member and the second transmission member being movably connected to the carrier. The first door window is connected to the first transmission member, and the second door window is connected to the second transmission member, a power input portion of the driving member is spaced apart from the first transmission member and the second transmission member along a height direction of the window opening, the driving member comprises a first output portion and a second output portion arranged along the extending direction of the opening and closing side, the first output portion is connected to the first transmission member, so as to drive the first transmission member to drive the first door window to move relative to the window opening, and the second output portion is connected to the second transmission member, so as to drive the second transmission member to drive the second door window to move relative to the window opening.

The technical solutions are further described in the following.

In one of the embodiments, the first door window and the second door window move in opposite directions to cooperate with each other to open or close the window opening.

In one of the embodiments, the carrier is connected to a guide rail, the guide rail is provided with a sliding groove extending along the extending direction of the opening and closing side, the first transmission member and the second transmission member are both movably provided in the sliding groove, the driving member is provided in the sliding groove, the power input portion of the driving member is arranged with the first transmission member and the second transmission member along a depth direction of the sliding groove, and the depth direction of the sliding groove corresponds to the height direction of the window opening.

In one of the embodiments, the sliding groove comprises a first groove body and a second groove body that are arranged in a misaligned manner along the height direction of the window opening and are in communication with each other, the first groove body is closer to the window opening than the second groove body, the first transmission member and the second transmission member are provided in the first groove body, and the driving member is provided in the second groove body.

In one of the embodiments, a side wall of the first groove body adjacent to the second groove body is provided with a limiting through hole extending along the extending direction of the opening and closing side, the first groove body is in communication with the second groove body through the limiting through hole, the first transmission member comprises a first transmission portion extending through the limiting through hole and connected to the first output portion, and the second transmission member comprises a second transmission portion extending through the limiting through hole and connected with the second output portion.

In one of the embodiments, the first transmission portion is a first rack portion, the second transmission portion is a second rack portion, the first output portion is engaged with the first rack portion, so as to drive the first rack portion to drive the first door window to move, and the second output portion is engaged with the second rack portion, so as to drive the second rack portion to drive the second door window to move.

In one of the embodiments, the power input portion of the driving member is a driving rack, the driving rack and each of the first rack portion and the second rack portion are arranged along the height direction of the window opening, the first output portion comprises a first driving gear and a reversing member, the second output portion comprises a second driving gear, the first driving gear is engaged with the driving rack, the second driving gear is engaged with both the driving rack and the second rack portion, the reversing member is engaged with the first rack portion, and the reversing member is engaged with the first driving gear, so that under a transmission of the reversing member, the first rack portion moves in a direction opposite to a moving direction of the second rack portion.

In one of the embodiments, the reversing member comprises at least one reversing gear, and the first driving gear is in transmission cooperation with the first rack portion through the at least one reversing gear.

In one of the embodiments, a side wall of the second groove body is further provided with a limiting groove extending along an extending direction of the second groove body, and the driving rack is movably provided in the limiting groove.

In one of the embodiments, the driving assembly further comprises a driving source, the driving source further comprises a driving gear portion, the driving gear portion is engaged with the driving rack to drive the driving rack to move, and the driving rack drives the first driving gear and the second driving gear to rotate.

In one of the embodiments, the first driving gear, the reversing member, the second driving gear, and the driving gear portion are spaced apart along an extending direction of the second groove body.

In one of the embodiments, the driving gear portion is provided between the first driving gear and the second driving gear, and the first driving gear is provided between the reversing member and the driving gear portion.

In one of the embodiments, the guide rail comprises a first guide rail and a second guide rail, the first guide rail and the second guide rail are arranged along the height direction of the window opening, the sliding groove is formed on one of the first guide rail and the second guide rail or the sliding groove is formed on each of the first guide rail and the second guide rail, two sets of the driving assemblies are provided, each set of the driving assembly is correspondingly arranged in one set of the sliding groove, and the first door window and the second door window are arranged between the first guide rail and the second guide rail.

In another aspect, the present disclosure further relates to a door window assembly including the window structure in any of the foregoing embodiments.

In another aspect, the present disclosure further relates to an automobile including the door window assembly in any of the foregoing embodiments.

The details of one or more embodiments of the present disclosure are provided in the accompanying drawings and the description hereinafter, so that other features, objectives, and advantages of the present disclosure are more comprehensible.

### BRIEF DESCRIPTION OF THE DRAWINGS

The accompanying drawings that constitute part of the present disclosure are intended to provide a further understanding of the present disclosure. The illustrative embodiments of the present disclosure as well as the description thereof are provided to explain the present disclosure, and do not constitute improper limitations to the present disclosure.

In order to provide a clearer description of the technical solution in the embodiments of the present disclosure, a brief introduction is given below to the accompanying drawings used in the description of the embodiments, obviously, the drawings in the following description are merely some embodiments of the application. For those of ordinary skill in the art, other drawings can also be obtained based on these drawings without involving any inventive effort.

In addition, the accompanying drawings are not drawn to a 1:1 scale, and the relative dimensions of each component are only illustrated in the drawings as an example, not necessarily drawn to true scale.

FIG. 1 is a bottom view of a window structure according to an embodiment.

FIG. 2 is a front view of a window structure according to an embodiment.

FIG. 3 is a schematic view of a carrier according to an embodiment.

FIG. 4 is a partial enlarged view of A in FIG. 2.

FIG. 5 is a cross-sectional view taken along a line A-A in FIG. 4.

FIG. 6 is a cross-sectional view taken along a line B-B in FIG. 4.

FIG. 7 is a cross-sectional view taken along a line C-C in FIG. 4.

FIG. 8 is a cross-sectional view taken along a line D-D in FIG. 4.

### REFERENCE NUMERALS

10, window structure; 100, carrier; 110, window opening; 112, opening and closing side; 200. window assembly; 210. first door window; 220. second door window; 300, driving assembly; 310, driving member; 312, power input portion; 314, first output portion; 3142, first driving gear; 3144, reversing member; 316, second output portion; 3162, second driving gear; 320, first transmission member; 322, first transmission portion; 330, second transmission member; 332, second transmission portion; 340, driving source; 342, driving gear portion; 400, guide rail; 410, sliding groove; 412, first groove body; 4122, limiting through hole; 414, second groove body; 4142, limiting groove; 420, first guide rail; and 430, second guide rail.

### DETAILED DESCRIPTION OF THE EMBODIMENTS

In order to make the objectives, features, and advantages of the present disclosure more apparent and understandable, the specific implementations of the present disclosure will be explained in detail below in conjunction with the accompanying drawings. In the following description, numerous specific details are set forth in order to facilitate a thorough understanding of the present disclosure. However, the present disclosure can be implemented in many other ways different from those described herein, and those skilled in the art can make similar modifications without departing from the spirit of the application, so that the present disclosure is not limited to the specific embodiments disclosed below.

In the description of the present disclosure, it is to be understood that the terms “center”, “longitudinal”, “transverse”, “length”, “width”, “thickness”, “upper”, “lower”, “front”, “rear”, “left”, “right”, “vertical”, “horizontal”, “top”, “bottom”, “inner”, “outer”, “clockwise”, “counterclockwise”, “axial”, “radial”, “circumferential”, etc. indicate the orientations or positional relationships on the basis of the drawings. These terms are only intended for facilitating illustrating the present disclosure and simplifying the illustration, rather than indicating or implying that the devices or elements referred thereto have to present particular orientations, and be constructed and operated in particular orientations, and therefore cannot be construed as limiting the present disclosure.

In addition, the terms “first” and “second” are only intended for illustrative purposes, rather than being construed as indicating or implying relative importance or implicitly designating the number of the technical features as indicated. Thus, the features modified by “first” and “second” may explicitly or implicitly include at least one said feature. In the illustrations of the present disclosure, the term “a plurality of” means at least two, for example two or three, unless otherwise explicitly and specifically defined.

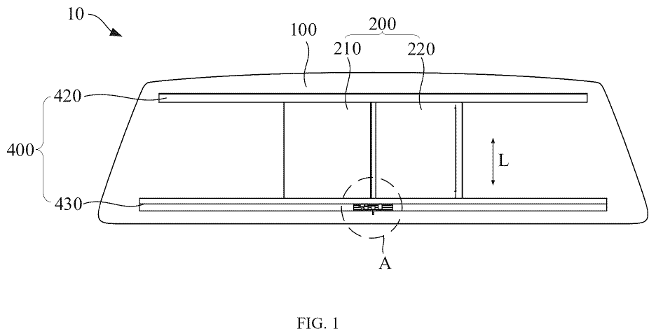

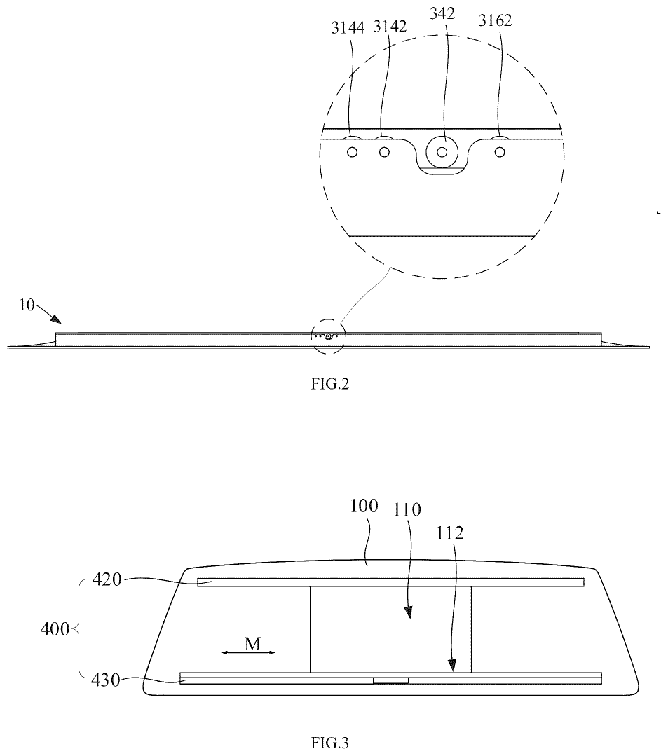

Referring to FIG. 1 to FIG. 3, a window structure 10 includes a carrier 100 and a window assembly 200. The carrier 100 is provided with a window opening 110. One side of the window opening 110 is an opening and closing side 112. The window assembly 200 includes a first door window 210 and a second door window 220 arranged along an extending direction M of the opening and closing side 112. The first door window 210 and the second door window 220 are configured to cooperate with each other to open or close the window opening 110.

The carrier 100 may be a rear windshield or a side door window of the automobile. Both the first door window 210 and the second door window 220 may be window glass.

The first door window 210 and the second door window 220 may open or close the window 110 by moving in opposite directions, that is, the first door window 210 and the second door window 220 may open or close the window opening 110 in an opposite motion manner.

In other embodiments, two window openings 110 is provided, and the two window openings 110 are spaced apart. The first door window 210 is moved relative to the carrier 100 to open or close one of the window openings 110, and the second door window 220 is moved relative to the carrier 100 to open or close the other window opening 110.

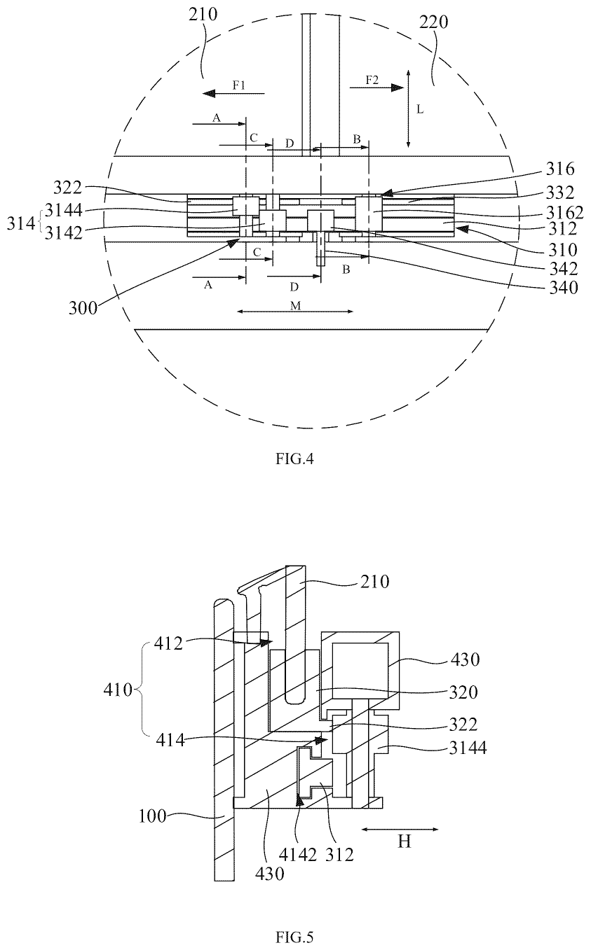

Referring to FIG. 2 and FIG. 4, the window structure 10 further includes a driving assembly 300. The driving assembly 300 includes a driving member 310, a first transmission member 320, and a second transmission member 330. The first transmission member 320 and the second transmission member 330 are arranged along the extending direction M of the opening and closing side 112, and both the first transmission member 320 and the second transmission member 330 are movably connected to the carrier 100. The first door window 210 is connected to the first transmission member 320, and the second door window 220 is connected to the second transmission member 330. The driving member 310 is spaced apart from the first transmission member 320 and the second transmission member 330 along a height direction Z of the window opening 110. The driving member 310 includes a first output portion 314 and a second output portion 316 arranged along the extending direction M of the opening and closing side 112. The first output portion 314 is connected to the first transmission member 320, so as to drive the first transmission member 320 to drive the first door window 210 to move relative to the window opening 110. The second output portion 316 is connected to the second transmission member 330, so as to drive the second transmission member 330 to drive the second door window 220 to move relative to the window opening 110.

Referring to FIG. 2 and FIG. 5 to FIG. 8, the carrier 100 is connected to a guide rail 400. The guide rail 400 is provided with a sliding groove 410 extending along the extending direction M of the opening and closing side 112. The first transmission member 320 and the second transmission member 330 are both movably provided in the sliding groove 410. The driving member 310 is provided in the sliding groove 410. The power input portion 312 of the driving member 310 is arranged with the first transmission member 320 and the second transmission member 330 along a depth direction L of the sliding groove 410. The depth direction of the sliding groove 410 corresponds to the height direction of the window opening 110. The height direction of the window opening 110 and the depth direction of the sliding groove 410 are both a direction L indicated in FIG. 4.

One or two guide rails 400 may be provided. The guide rail 400 is provided to limit the moving directions of the first door window 210 and the second door window 220.

For example, referring to FIG. 2, in some embodiments, the guide rail 400 includes a first guide rail 420 and a second guide rail 430. The first guide rail 420 and the second guide rail 430 are arranged along the height direction L of the window opening 110. The sliding groove 410 is formed on one of the first guide rail 420 and the second guide rail 430. By providing the first guide rail 420 and the second guide rail 430 in the height direction L of the window opening 110, the stability of the movement of the first door window 210 and the second door window 220 is improved.

In other embodiments, the sliding groove 410 is formed on each of the first guide rail 420 and the second guide rail 430. Two sets of the driving assemblies 300 are provided. Each set of the driving assembly 300 is correspondingly arranged in one set of the sliding groove 410. The first door window 210 and the second door window 220 are arranged between the first guide rail 420 and the second guide rail 430. By providing the sliding groove 410 on both the first guide rail 420 and the second guide rail 430, the stability of the movement of the first door window 210 and the second door window 220 can be improved.

The following exemplary embodiments are all described based on the premise that the sliding groove 410 is provided on the second guide rail 430.

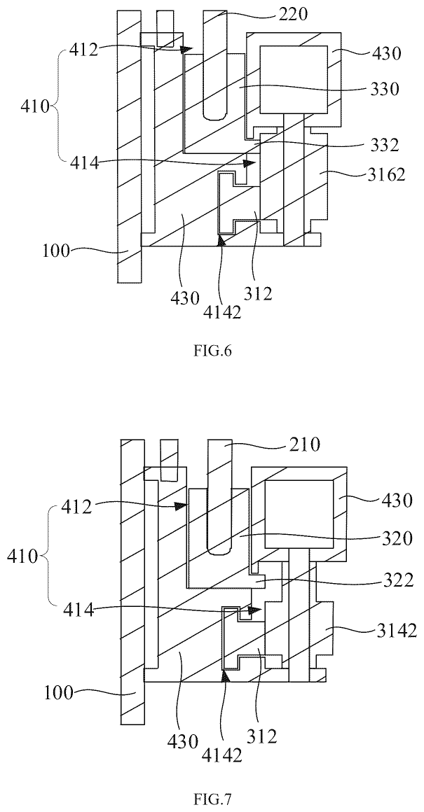

Referring to FIG. 5 and FIG. 6, the sliding groove 410 includes a first groove body 412 and a second groove body 414 that are arranged in a misaligned manner along the height direction L of the window opening 110 and are in communication with each other. The first groove body 412 is closer to the window opening 110 than the second groove body 414. The first transmission member 320 and the second transmission member 330 are provided in the first groove body 412. The driving member 310 is provided in the second groove body 414. In this way, the first groove body 412 and the second groove body 414 are arranged in a misaligned manner. At this time, when the first transmission member 320 and the second transmission member 330 are accommodated in the first groove body 412 and the driving member 310 is accommodated in the second groove body 414, the first output portion 314 and the second output portion 316 can be connected to the first transmission member 320 and the second transmission member 330 in a width direction of the sliding groove 410 (referring to a direction H in FIG. 5), thereby reducing a space occupied by the driving assembly 300 in the height direction of the sliding groove 410.

Referring to FIG. 5 and FIG. 6, a side wall of the first groove body 412 adjacent to the second groove body 414 is provided with a limiting through hole 4122 extending along the extending direction M of the opening and closing side 112, and the first groove body 412 is in communication with the second groove body 414 through the limiting through hole 4122. Referring to FIG. 4, FIG. 5 and FIG. 6, the first transmission member 320 includes a first transmission portion 322 extending through the limiting through hole 4122 and connected to the first output portion 314. The second transmission member 330 includes a second transmission portion 332 extending through the limiting through hole 4122 and connected to the second output portion 316. The first limiting through hole 4122 can limit the first transmission portion 322, and thus limit the first transmission member 320, so that the first transmission member 320 moves in the extending direction M of the opening and closing side 112, that is, the first transmission member 320 moves in the extending direction of the first groove body 412 and the extending direction of the limiting through hole 4122. Similarly, the second limiting through hole 4122 can limit the second transmission portion 332, and thus limit the second transmission member 330, so that the second transmission member 330 moves in the extending direction M of the opening and closing side 112, that is, the second transmission member 330 moves in the extending direction of the second groove body 414 and the extending direction of the limiting through hole 4122.

Referring to FIG. 5 and FIG. 6, the first transmission member 320 and the second transmission member 330 may be approximately L-shaped. When the first transmission member 320 is mounted in the first groove body 412, the first transmission portion 322 extends into the limiting through hole 4122. When the second transmission member 330 is mounted in the second groove body 414, the second transmission portion 332 extends into the limiting through hole 4122.

In some embodiments, the first transmission portion 322 is a first rack portion, and the second transmission portion 332 is a second rack portion. The first output portion 314 is engaged with the first rack portion, so as to drive the first rack portion to drive the first door window 210 to move. The second output portion 316 is engaged with the second rack portion, so as to drive the second rack portion to drive the second door window 220 to move.

The first output portion 314 and the second output portion 316 may both be corresponding gears or gear sets, and the specific types thereof may be selected as required.

For example, in an embodiment, the power input portion 312 of the driving member 310 is a driving rack, and the driving rack and each of the first rack portion and the second rack portion are arranged along the height direction L of the window opening 110. Referring to FIG. 4 to FIG. 7, the first output portion 314 includes a first driving gear 3142 and a reversing member 3144. The second output portion 316 includes a second driving gear 3162. The first driving gear 3142 is engaged with the driving rack. The second driving gear 3162 is engaged with both the driving rack and the second rack portion. The reversing member 3144 is engaged with the first rack portion, and the reversing member 3144 is engaged with the first driving gear 3142, so that under the transmission of the reversing member 3144, the first rack portion moves in a direction opposite to the moving direction of the second rack portion.

In use, the movement of the driving rack moves to drive the first driving gear 3142 and the second driving gear 3162 to rotate in the same direction. Under the action of the second driving gear 3162, the second rack portion moves to drive the second door window 220 to move. The first driving gear 3142 is in transmission cooperation with the first rack portion through the reversing member 3144, so that under the transmission of the reversing member 3144, the first rack portion moves in a direction opposite to the moving direction of the second rack portion. In this way, the first door window 210 and the second door window 220 may be moved in opposite directions, and the window opening 110 may be opened or closed in an opposite motion manner.

For example, the first door window 210 opens the window opening 110 in a first direction F1, and the second door window 220 opens the window opening 110 in a second direction F2. Directions F1 and F2 are opposite to each other.

It should be understood that in order to achieve engagement with both the first rack portion and the first driving gear 3142, the reversing member 3144 should include corresponding toothed structures. For example, the reversing member 3144 may include at least one reversing gear, and the first driving gear 3142 cooperates with the first rack portion through the at least one reversing gear. The reversing gears of the reversing member 3144 engage and cooperate with each other. The number of reversing gears can be determined as needed, but it should be satisfied that under the action of the reversing member 3144, the moving direction of the first rack portion is opposite to the moving direction of the second rack portion.

Referring to FIG. 4, in this embodiment, the reversing member 3144 includes one reversing gear. An end of the reversing gear is engaged with the first driving gear 3142, and another end of the reversing gear is engaged with the first rack portion.

Referring to FIG. 4, the first driving gear 3142, the reversing member 3144, the second driving gear 3162, and the driving gear portion 342 are spaced apart along the extending direction of the second groove body 414. In this way, the first driving gear 3142, the reversing member 3144, the second driving gear 3162, and the driving gear portion 342 are distributed more compactly, and the space occupied by the driving assembly 300 is reduced.

Further, referring to FIG. 4, since the first door window 210 and the second door window 220 are arranged along the extending direction M of the opening and closing side 112, the driving gear portion 342 is provided between the first driving gear 3142 and the second driving gear 3162, and the first driving gear 3142 is provided between the reversing member 3144 and the driving gear portion 342. The first driving gear 3142 and the second driving gear 3162 are distributed on both sides of the driving gear portion 342, and the corresponding reversing member 3144 is arranged on one side of the first driving gear 3142. Compared with other distribution modes, the arrangement of this embodiment can fully utilize a mounting space formed between the first driving gear 3142 and the second driving gear 3162, so that the driving assembly 300 is more compact, and the space occupied by the driving assembly 300 is further reduced.

Referring to FIG. 5 and FIG. 6, the side wall of the second groove body 414 is further provided with a limiting groove 4142 extending along the extending direction of the second groove body 414, and the driving rack is movably provided in the limiting groove 4142. In this way, under the limiting function of the limiting groove 4142, the driving rack can only move in the extending direction of the second groove body 414.

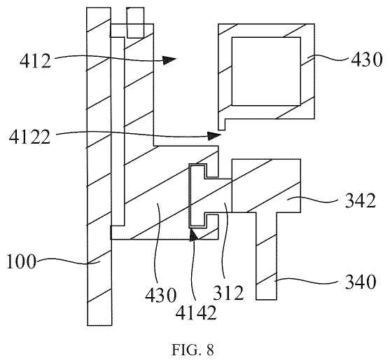

Referring to FIG. 4 and FIG. 8, the driving assembly 300 further includes a driving source 340. The driving source 340 further includes a driving gear portion 342. The driving gear portion 342 is engaged with the driving rack to drive the driving rack to move, and thus the driving rack drives the first driving gear 3142 and the second driving gear 3162 to rotate. The driving source 340 may be a motor, and an output shaft of the motor is provided with the driving gear portion 342.

Specifically, referring to FIG. 4, the second groove body 414 is provided with a mounting through hole. An end of the motor provided with the driving gear portion 342 extends into the second groove body 414 along the mounting through hole and is engaged with the driving rack.

In addition, an embodiment relates to a door window assembly including the window structure 10 in any of the foregoing embodiments.

In addition, an embodiment relates to an automobile including the door window assembly in any of the foregoing embodiments.

In the door window assembly and the automobile, the first transmission member 320 is driven by the first output portion 314 to drive the first door window 210 to move, and the second transmission member 330 is driven by the second output portion 316 to drive the second door window 220 to move, so that the first door window 210 and the second door window 220 open or close the window opening 110 by moving relative to the window opening 110. The first transmission member 320 and the second transmission member 330 are arranged along the extending direction M of the opening and closing side 112. The power input portion 312 of the driving member 310 is spaced apart from the first transmission member 320 and the second transmission member 330 along the height direction M of the window opening 110. The first output portion 314 and the second output portion 316 are arranged along the extending direction M of the opening and closing side 112. In this way, the whole driving assembly 300 is arranged along the extending direction M of the opening and closing side 112, and the driving assembly 300 can be relatively narrow in the height direction of the window opening 110, so that the whole driving assembly 300 is relatively compact in the height direction of the window opening 110, thereby reducing the space occupied by the driving assembly 300.

In the present disclosure, unless otherwise expressly specified and defined, the terms “mounted”, “connected to”, “coupled” and “fixed” should be understood in a broad sense, for example, fixedly connected or detachably connected, or integrated; mechanically connected or electrically connected; directly connected or indirectly connected through an intermediate medium, or in an interior communication or mutual interaction relationship between two elements, unless otherwise specifically defined. For those of ordinary skill in the art, the specific meanings of the above-described terms in the present disclosure may be understood according to specific circumstances.

In the present disclosure, unless otherwise expressly stated and defined, the first feature, when being referred to as being located “above” or “below” the second feature, may be in direct contact with the second feature, or in indirect contact with the second feature via an intermediate feature. Moreover, the first feature, when being referred to as being disposed “on”, “above” and “over” the second feature, may be disposed right above or obliquely above the second feature, or simply disposed at a level higher than the second feature. The first feature, when being referred to as being disposed “under”, “below” and “beneath” the second feature, may be disposed directly below or obliquely below the second feature, or simply disposed at a level lower than the second feature.

It should be noted that, when an element is referred to as being “fixed to” or “disposed on” another element, it may be directly on the other element or may also be present with an intermediate element. When an element is referred to as being “connected” to another element, it may be directly connected to the other element or may be present with an intermediate element at the same time. The terms “vertical”, “horizontal”, “up”, “down”, “left”, “right” and similar expressions used herein are only for the purpose of illustration, rather than presenting the only ways for implementation.

The technical features of the embodiments above may be combined arbitrarily. To make the description concise, not all possible combinations of the technical features in the above embodiments are described. However, as long as there are no contradictions in the combinations of these technical features, all of the combinations should be considered to be within the scope of the specification.

The embodiments above only represent several implementation modes of the present disclosure, and the description thereof is relatively specific and detailed, but it should not be construed as limiting the scope of the patent. It should be noted that for those skilled in the art, various modifications and improvements may be made without departing from the concept of the present disclosure, and all these modifications and improvements belong to the protection scope of the present disclosure. Therefore, the scope of protection of the patent application should be subject to the appended claims.

1. A window structure comprising:
a carrier provided with a window opening, a side of the window opening being an opening and closing side;
a window assembly comprising a first door window and a second door window that are arranged along an extending direction of the opening and closing side, the first door window and the second door window being configured to cooperate with each other to open or close the window opening; and
a driving assembly comprising a driving member, a first transmission member, and a second transmission member, the first transmission member and the second transmission member being arranged along the extending direction of the opening and closing side, and both the first transmission member and the second transmission member being movably connected to the carrier;
wherein the first door window is connected to the first transmission member, and the second door window is connected to the second transmission member, a power input portion of the driving member is spaced apart from the first transmission member and the second transmission member along a height direction of the window opening, the driving member comprises a first output portion and a second output portion arranged along the extending direction of the opening and closing side, the first output portion is connected to the first transmission member, so as to drive the first transmission member to drive the first door window to move relative to the window opening, and the second output portion is connected to the second transmission member, so as to drive the second transmission member to drive the second door window to move relative to the window opening.

2. The window structure according to claim 1, wherein the first door window and the second door window move in opposite directions to cooperate with each other to open or close the window opening.

3. The window structure according to claim 1, wherein the carrier is connected to a guide rail, the guide rail is provided with a sliding groove extending along the extending direction of the opening and closing side, the first transmission member and the second transmission member are both movably provided in the sliding groove, the driving member is provided in the sliding groove, the power input portion of the driving member is arranged with the first transmission member and the second transmission member along a depth direction of the sliding groove, and the depth direction of the sliding groove corresponds to the height direction of the window opening.

4. The window structure according to claim 3, wherein the sliding groove comprises a first groove body and a second groove body that are arranged in a misaligned manner along the height direction of the window opening and are in communication with each other, the first groove body is closer to the window opening than the second groove body, the first transmission member and the second transmission member are provided in the first groove body, and the driving member is provided in the second groove body.

5. The window structure according to claim 4, wherein a side wall of the first groove body adjacent to the second groove body is provided with a limiting through hole extending along the extending direction of the opening and closing side, the first groove body is in communication with the second groove body through the limiting through hole, the first transmission member comprises a first transmission portion extending through the limiting through hole and connected to the first output portion, and the second transmission member comprises a second transmission portion extending through the limiting through hole and connected with the second output portion.

6. The window structure according to claim 5, wherein the first transmission portion is a first rack portion, the second transmission portion is a second rack portion, the first output portion is engaged with the first rack portion, so as to drive the first rack portion to drive the first door window to move, and the second output portion is engaged with the second rack portion, so as to drive the second rack portion to drive the second door window to move.

7. The window structure according to claim 6, wherein the power input portion of the driving member is a driving rack, the driving rack and each of the first rack portion and the second rack portion are arranged along the height direction of the window opening, the first output portion comprises a first driving gear and a reversing member, the second output portion comprises a second driving gear, the first driving gear is engaged with the driving rack, the second driving gear is engaged with both the driving rack and the second rack portion, the reversing member is engaged with the first rack portion, and the reversing member is engaged with the first driving gear, so that under a transmission of the reversing member, the first rack portion moves in a direction opposite to a moving direction of the second rack portion.

8. The window structure according to claim 7, wherein the reversing member comprises at least one reversing gear, and the first driving gear is in transmission cooperation with the first rack portion through the at least one reversing gear.

9. The window structure according to claim 7, wherein a side wall of the second groove body is further provided with a limiting groove extending along an extending direction of the second groove body, and the driving rack is movably provided in the limiting groove.

10. The window structure according to claim 7, wherein the driving assembly further comprises a driving source, the driving source further comprises a driving gear portion, the driving gear portion is engaged with the driving rack to drive the driving rack to move, and the driving rack drives the first driving gear and the second driving gear to rotate.

11. The window structure according to claim 10, wherein the first driving gear, the reversing member, the second driving gear, and the driving gear portion are spaced apart along an extending direction of the second groove body.

12. The window structure according to claim 11, wherein the driving gear portion is provided between the first driving gear and the second driving gear, and the first driving gear is provided between the reversing member and the driving gear portion.

13. The window structure according to claim 3, wherein the guide rail comprises a first guide rail and a second guide rail, the first guide rail and the second guide rail are arranged along the height direction of the window opening, the sliding groove is formed on one of the first guide rail and the second guide rail or the sliding groove is formed on each of the first guide rail and the second guide rail, two sets of the driving assemblies are provided, each set of the driving assembly is correspondingly arranged in one set of the sliding groove, and the first door window and the second door window are arranged between the first guide rail and the second guide rail.

14. A door window assembly, comprising the window structure according to claim 1.

15. An automobile, comprising the door window assembly according to claim 14.
